(19) United States
(12) Patent Application Publication
(10) Pub. No.: US 2014/0239086 A1
(43) Pub. Date: Aug. 28, 2014

(54) INTERACTIVE ENTERTAINMENT APPARATUS AND SYSTEM AND A METHOD OF INTERACTING WITH WATER TO PROVIDE AUDIO, VISUAL, OLFACTORY, GUSTATORY OR TACTILE EFFECT

(71) Applicant: Kwok Chuen Wong, Hong Kong (CN)

(72) Inventor: Kwok Chuen Wong, Hong Kong (CN)

(73) Assignee: FINNACGOAL LIMITED, Hong Kong (HK)

(21) Appl. No.: 13/823,487

(22) PCT Filed: Feb. 22, 2013
(86) PCT No.: PCT/CN2013/071762

§ 371 Date: Mar. 14, 2013

(51) Int. Cl. B05B 17/08

(52) U.S. Cl. CPC B05B 17/08
USPC 239/18

(57) ABSTRACT

An interactive entertainment apparatus and system and a method of interacting with water to provide audio, visual, olfactory, gustatory and/or tactile effects are provided. In one embodiment, the apparatus and system comprise one or more imagery multilevel channel communications input and/or multilevel channel communications output device(s), one or more sound multilevel channel communications input and/or multilevel channel communications output device(s); one or more camera and/or motion multilevel channel communications input and/or multilevel channel communications input device(s); one or more nozzle assemblies for spraying and/or emitting liquid and/or vapour and/or gas that can produce lively and entertaining liquid and/or vapour and/or gas screen and/or middle drop(s)/screen(s)and/or other arena-like and/or skyscreen-like arrangement(s) located at or near the centre(s) or focal zone(s) of the theatrical arrangement(s) for the entertainment apparatus and system, on to which liquid and/or vapour and/or gas screen and/or contour arrangement(s) can be projected and/or augmented by harmonized and/or sychronized light and/or laser source for entertaining lighting and/or laser shows; one or more sound generating and/or broadcasting device(s); one or more light and/or laser source(s); one or more tactile stimulus multilevel channel communications input and/or multilevel channel communications output device(s) and/or one or more heating and/or cooling device(s) adapted to provide a tactile sensation of three-dimensional movement(s), motion(s) and/or tilting and/or temperature alteration(s) or variation(s); one or more olfactory stimulus multilevel channel communications input and/or multilevel channel communications output device(s); one or more gustatory stimulus multilevel channel communications input and/or multilevel channel communications output device(s), according to the occurrence of one or more events (random, reconfigurable and/or pre-set) and/or the multilevel channel communications input from one or more user-interface device(s), when activated automatically or on the demand(s), option(s) and/or desire(s) of the user(s); one or more device(s) modulator and/or controller which modulates and/or controls one or more of the above devices and/or one or more parameters of the features of the invention; and one or more interactive microprocessing, computing and/or data-transmission system(s) and/or device(s) to capture, animate, digitize, vary, modify and co-ordinate light emissions, sound or musical note and/or tune broadcasting, tactile stimulus multilevel channel communications input and/or multilevel channel communications output, olfactory stimulus multilevel channel communications input and/or multilevel channel communications output, gustatory stimulus multilevel channel communications input and/or multilevel channel communications output, and/or dancing water trajectories with random, reconfigurable and/or pre-set motions and/or sound multilevel channel communications inputs and/or multilevel channel communications output, produced and/or caused by and/or through interaction of human, animal and/or objects, into control multilevel channel communications inputs, data and/or signals delivered automatically or on the demand(s), option(s) and/or desire(s) of the user(s) to one or more device controllers for controlling the trajectory(ies) of liquid and/or vapour and/or gas emitted from the nozzle assembly(ies), the sound generating and/or broadcasting, the mood, soft or hard lighting changes and/or laser renditions to produce life-like, integrated, artistic and featured entertaining performances automatically or on the demand(s), option(s) and/or desire(s) of the user(s).

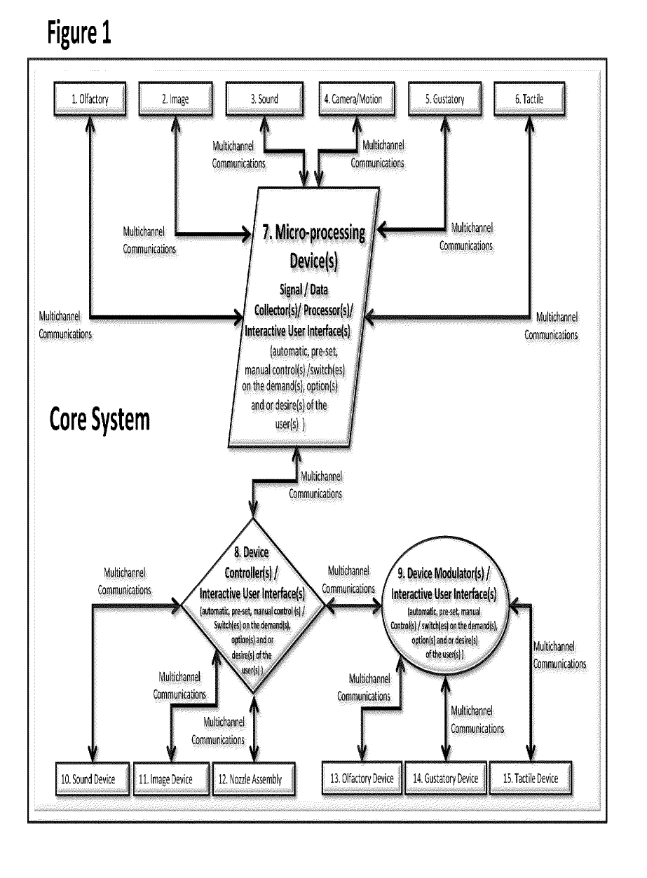

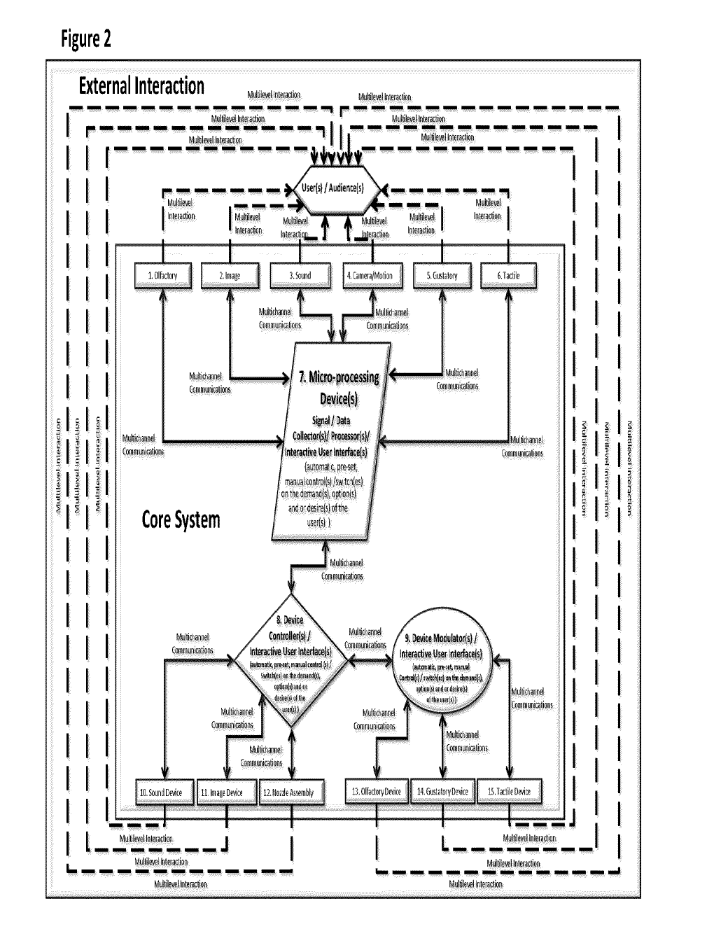

### BACKGROUND OF THE INVENTION

For centuries, water fountains have been in use to adorn or enliven public places to bring about pleasing and enjoyable environments with visual displays and sounds of free-flowing and moving water through gravitation effects, coupled at times with sculptures and ornaments to enhance their appearances, although such water fountains are usually passive structures which are not designed to be responsive directly to the presences of motions or actions of humans, animals or objects in their vicinities.

A normal “dancing” water-fountain would, nevertheless, end as a completed cycle, and the fountain's spraying (and lighting, lighting only, if any, not any laser show) would then have to be repeated as yet another iteration of a fixed cycle. Invariably, after a few snap-shots taken, people would no longer be very interested in such a fountain, and the same would cease to be a sought out point of attraction for repeated visits. Should the people come back to such a fountain, it would be more for the space and the associated ambience. Any change to the operation of such pre-set water fountain would entail costly and time consuming manual adjustments, making the practice unsustainable for the long run.

A water fountain dancing distinctively to the tune being played, augmented with laser shows; will employ local talents and deploy local capabilities to make such a fountain into a showcase. To make a water fountain dance to a tune (hence each piece of music should engender dynamically a different dance) essentially, one needs to programme nozzles for spraying to musical variations. First of all, associate different sizes of nozzles to different musical instruments. Then make a nozzle to spray a height in accordance with Do-Re-Me . . . being played; make the duration of a spray to last a musical note's beat length, and add twists and turns in tandem with the now playing musical piece's crescendos coupled with animated acts choreographed with the music and the fountain's dance.

It is one of the objectives of the present invention to provide, automated or on the demand(s), option(s) and/or desire(s) of the user(s), a new type of light, sound and water fountain coupling with olfactory stimulus multilevel channel communications input and/or multilevel channel communications output (wired and/or wireless, electronic, electrical and/or mechanical) system(s), circuit(s), sensor(s), and/or device(s), gustatory stimulus multilevel channel communications input and/or multilevel channel communications output (wired and/or wireless, electronic, electrical and/or mechanical) system(s), circuit(s) and/or device(s) and/or tactile stimulus multilevel channel communications input and/or multilevel channel communications output (wired and/or wireless, electronic, electrical and/or mechanical) system(s), circuit(s) and/or device(s), that responds to light imageries, sounds and motions of humans, animals and/or objects to produce life-like, integrated, stimulating, dramatic, artistic, aesthetic, sonic, musical, picturesque and featured entertaining performances and attainments choregraphed with light, music and water dance.

It is of note that various different water fountain entertainment apparatuses and systems are known in the state of the art.

U.S. Pat. No. 7,402,743 discloses method and apparatus entraining interactive media players into a sustained experience of as a perceived simultaneity and spatial superposition between a non-tactile, full body input control process and immersive multi-sensory feedback, and asynchronous player input actions and (MIDI tempo) clock-synchronous media feedback events or multi-sensory events fused into an integral event perception, this being between musical sound (hearing), visual responses (sight), and body kinesthetic (radial extension, angular position, height, speed, timing, and precision). This non-tactile interface process and multi-sensory feedback “look and feel” is embodied as an optimal ergonomic human interface for interactive music and as a six-degrees-of-freedom full-body-interactive immersive media controller. Nevertheless, the method and apparatus so disclosed is related to tracing of body-parts' movements to generate control data and/or signals to output music. Although the patent application materials submitted are highly elaborated, the apparatus nevertheless harbors on common technologies and well-reiterated concepts. Its novelty lies in making a “six-degrees-of-freedom full-body-interactive immersive controller.

U.S. Pat. No. 8,106,283 disclosed a performance interface system that includes a motion detector provided for movement with a performer, and a control system for receiving detection data transmitted from the motion detector and controlling a performance of a tone in response to the received detection data. State of a performer's motion is detected via a sensor of the motion detector, and detection data representative of the detected motion state is transmitted to the control system. The control system receives the detection data from the motion detector, analyzes the performer's motion on the basis of the detection data, and then controls a tone performance in accordance with the analyzed data. With this arrangement, the performer can readily take part in the tone performance in the control system. For example, as the performer moves his or her hand, leg or trunk while listening to a manual or automatic performance of a music piece being carried out by a performance apparatus of the control system, the motion detector detects the performer's motion and transmits corresponding detection data to the control system, which in turn variably controls a predetermined one of tonal factors in the music piece performance. This arrangement can readily provide interactive performance control and thereby allows an inexperienced or unskilled performer to take part in a performance with enjoyment.

The present invention carries out random samplings on group movements and group noise and sound and/or musical levels as well as in tunes, tempo and/or rhythm and the position and/or notation on a musical stave, the clef and relative length of each note, beat and/or bar, and the crescendos and diminuendos of sonic, musical renditions being broadcasted. The present invention will translate the sampled data and/or signals into musical notes, and not directly as multilevel channel communications output device control data and/or signals. The interactively, vicariously generated musical notes either define and multilevel channel communications output a choreographed water dance or to enhance a selected musical performances. Not the least, the said interactively data, signals and/or commands collected, generated and/or augmented can be used to work as intriguing surprises to the audience of the entertainment apparatus and system, for example, a Master of Ceremony, amid a water dance performance, may prompt the audience to sing along and cause interactive and reactive responses to and/or from the entertainment apparatus and system to produce the life-like, integrated, stimulating, dramatic, artistic, aesthetic, sonic, musical, picturesque and featured performances and attainments choregraphed with light, music and water dance, automatically or on the demand(s), option(s) and/or desire(s) of the user(s).

U.S. Pat. No. 6,267,297 discloses a programmable dispenser, especially for dispensing an olfactory stimulating material such as an air freshener composition, wherein the dispenser can be programmed so as to be operational within a wide variety of operating modes, such as starting and ending operations at specific times during the day, being operational during specific days of the week, and dispensing frequency (i.e., in the case of an aerosol or pump source) and/or intensity (i.e., in the case of a gel or cartridge source). Nevertheless, the disclosed programmable dispenser is only an improvement on the traditional static sanitary spraying mechanism by embedding a timer and interactive microprocessor to regulate the timing and amount of spraying to be dispensed and concomitantly to assess and to alert the need to refill. The present invention includes, wired and/or wireless, device modulator(s), switch(es) and/or controller(s) which, when activated automatically or on the demand(s), option(s) and/or desire(s) of the user(s), capture, incorporate, adjust, coordinate, synchronize, integrate with one or more of the other hardware of the invention the full effects, functions and controls of one or more olfactory stimulus multilevel channel communications input and/or multilevel channel communications output (wired and/or wireless, electronic, electrical and/or mechanical) system(s), circuit(s) and/or device(s), including, without limitation, pump sprayer(s), atomizer(s) and/or aerosol device(s) with liquid container(s), that delivers and/or releases (including, without limitation, timed multilevel channel communications output and/or release) measured and/or minute amounts of fragrances and/or other olfactory compositions, dispersions, emulsions, solutions and/or atomized particles and/or olfactory stimulus emitting substances, materials and/or matters commonly used and/or exploited in the field of perfumery and/or olfactory effects, into the atmosphere for immediate detection by the olfactory senses (including, without limitation, short-lived and/or long-lasting sensations), according to the occurrence of one or more events (random, reconfigurable and/or pre-set) and/or the multilevel channel communications input from one or more user-interface and/or computer-interface device(s) for enabling, disabling and/or adjusting such device(s), to produce the life-like, integrated, stimulating, dramatic, artistic, aesthetic, sonic, musical, picturesque and featured performances and attainments choregraphed with light, music and water dance incorporating olfactory effects, automatically or on the demand(s), option(s) and/or desire(s) of the user(s).

U.S. Pat. No. 8,106,283 discloses a performance interface system includes a motion detector provided for movement with a performer, and a control system for receiving detection data transmitted from the motion detector and controlling a performance of a tone in response to the received detection data. State of a performer's motion is detected via a sensor of the motion detector, and detection data representative of the detected motion state is transmitted to the control system. The control system receives the detection data from the motion detector, analyzes the performer's motion on the basis of the detection data, and then controls a tone performance in accordance with the analyzed data. With this arrangement, the performer can readily take part in the tone performance in the control system. For example, as the performer moves his or her hand, leg or trunk while listening to a manual or automatic performance of a music piece being carried out by a performance apparatus of the control system, the motion detector detects the performer's motion and transmits corresponding detection data to the control system, which in turn variably controls a predetermined one of tonal factors in the music piece performance. This arrangement can readily provide interactive performance control and thereby allows an inexperienced or unskilled performer to take part in a performance with enjoyment. Nevertheless, the performance interface system simply allows user controls after the start of an automatic performance by monitoring a single object's motions. The present invention carries out random samplings of collective motions, noise/voice levels of and/or from group audience to generate random data, signals and/or commands to be translated, converted, incorporated and/or assimilated into other wired and/or wireless, electronic, electrical and/or mechanical inputs for a coordinated and choreographed enhancement, or an independent show, or a generation intriguing surprises to the group audience of the entertainment apparatus and system,

### SUMMARY OF THE INVENTION

An interactive apparatus and system for providing audio, visual, olfactory, gustatory, tactile and water entertainment automated or on the demand(s), option(s) and/or desire(s) of the user(s) is provided. The proposed interactive apparatus and system make use of computer controls 7, 8, 9 and simulations 10, 11, 12, 13, 14, 15 to enliven the traditional water fountains, with principles of automation, dynamism, situationality, interaction, coordination, reconfigurability, aesthetic and artistic impressions in mind. The heights, durations, twist, and turns of the to-be-systematized nozzle spray assembly(ies) 12; and the lighting up of designated beams 11 whose hues, saturations, luminescence, intensities, durations, and mixes; and the optional Laser shows along with the required co-ordination and choreography in tandem with piece(s) of music being played; and dynamic control by computers and device controllers and modulators 7, 8, 9 which are programmed to regulate the said multilevel channel communications outputs as per the multilevel channel communications inputs they receive from various digitized source(s). As multilevel channel communications input thus digitized, processes made re-configurable, multilevel channel communications output accordingly controlled, the set up of this invention can be automated and deliver a variety of spray-laser shows automatically or on the demand(s), option(s) and/or desire(s) of the user(s) including (amongst others) a method of interaction with water to provide audio, visual, olfactory, gustatory and/or tactile effects.

In respect of the physical construction of this invention, it is envisaged that the current state of the art of various disciplines of interest as stated can be employed to deliver most the required functionalities, prototypes of proofs of concepts would need be built, nevertheless, as to conduct gap analysis. It can be foreseen that at least the computer programming part of the construction for musical and show multilevel channel communications input and the processing of such to precisely drive the device controllers and modulator 8, 9 so as to deliver the desired multilevel channel communications output would have to be proprietarily built. The key component is to have a middle drop/screen 11, 12 (as opposed to back drop/screen), built from hydraulic spray or otherwise, onto which a Laser show could be projected. It is not mandatory to host a Laser show all the time; a dancing to the tune being played (hence a different dance/spray for a different tune) along with coordinated lighting show already renders one a spectacular performance.

On the artistic rendition side, while it can be made as simple as a Laser show independently projected onto a cascaded waterfall as the screen, the preferred embodiment is to have some acts well coordinated with music 10, lightings 11, and “dancing” sprays 12. This aspect would require substantial experimentations and would try ones' abilities and drumming up commercializable episodes in the long run. It is also highly desirable to have the design for every one such a water fountain theatre uniquely developed, to be well blended in with the particular environment and culture.

It is highly desirable to have audience produced, ad hoc, and/or interactively generated shows to be staged. In this regard, sensor(s) and/or camera(s) of various types can be strategically located at or around the water-fountain/aquatic theatre(s) to capture the movements and/or sounds (including, without limitation, their randomness) of and produced by the audience so as to generate the required musical and other relevant multilevel interaction inputs for an ad hoc, interactively, dynamically produced performance.

The present invention related to the field of interactive entertainment apparatus and system and a method of interacting with water to provide, automatically or on the demand(s), option(s) and/or desire(s) of the user(s), audio, visual, olfactory, gustatory and/or tactile effects including (amongst others) interaction of light emissions 11, sound or musical note and/or tune broadcasting 10 and/or nozzle assembly(ies) 12 for spraying and/or emitting liquid and/or vapour and/or gas trajectories with ad hoc, random, reconfigurable and/or pre-set imagery and/or motion 2, 4 and/or sound multilevel channel communications inputs 3, produced and/or caused by and/or through interaction of human, animal and/or objects, coupled, combined and/or incorporated with one or more interactive device connector, switch, selector and/or controller (wired and/or wireless, electronic, electrical and/or mechanical) system(s), circuit(s) and/or device(s) 8, 9 connected to and/or to be used in conjunction with one or more gustatory stimulus multilevel channel communications input and/or multilevel interaction output (wired and/or wireless, electronic, electrical and/or mechanical) system(s), circuit(s) 14 and/or device(s); one or more tactile stimulus multilevel channel communications input and/or multilevel interaction output (wired and/or wireless, electronic, electrical and/or mechanical) system(s), circuit(s) and/or device(s) 15; and one or more olfactory stimulus multilevel channel communications input and/or multilevel interaction output (wired and/or wireless, electronic, electrical and/or mechanical) system(s), circuit(s) and/or device(s) 13, including, without limitation, pump sprayer(s), atomizer(s) and/or aerosol device(s) with liquid container(s), that delivers and/or releases (including, without limitation, timed multilevel interaction output and/or release) measured and/or minute amounts of fragrances and/or other olfactory compositions, dispersions, emulsions, solutions and/or atomized particles, including, without limitation, mixtures, matrices, hybrids and/or combinations of natural, organic, inorganic, synthetic, and/or other odoriferous substances, materials and/or matters, including, without limitation, other solvents, adjuvants, additives, surfactants and/or olfactory stimulus emitting substances, materials and/or matters commonly used and/or exploited in the field of perfumery and/or olfactory effects, into the atmosphere for immediate detection by the olfactory senses (including, without limitation, short-lived and/or long-lasting sensations); one or more gustatory stimulus multilevel channel communications input and/or multilevel interaction output (wired and/or wireless, electronic, electrical and/or mechanical) system(s), circuit(s) and/or device(s) 14, to produce life-like, integrated, stimulating, dramatic, artistic, aesthetic, sonic, musical, picturesque and featured performances and attainments choregraphed with light, music and water dance, automatically or on the demand(s), option(s) and/or desire(s) of the user(s).

### BRIEF DESCRIPTION OF THE DRAWINGS

The apparatus and system in accordance with the invention are more particularly exemplified in detail in conjunction with the accompanied block system diagram.

### DETAILED DESCRIPTION OF PREFERRED EMBODIMENTS

In one preferred embodiment, the invention comprises one or more imagery multilevel interaction input and/or capturing (wired and/or wireless, electronic, electrical and/or mechanical) system(s), circuit(s) and/or device(s) 2, one or more sound multilevel interaction input and/or capturing (wired and/or wireless, electronic, electrical and/or mechanical) system(s), circuit(s) and/or device(s) 3; one or more camera or motion multilevel interaction input and/or sensoring (wired and/or wireless, electronic, electrical and/or mechanical) system(s), circuit(s) and/or device(s) 4; one or more nozzle assembly(ies) for spraying and/or emitting liquid and/or vapour and/or gas with different sizes of nozzles associated (automatically, specifically and/or randomly) 12 with different musical instruments 3 and to spray a height in accordance with Do-Re-Me . . . being played, and for duration of a spray to last a musical note's beat length, and to add twists and turns in tandem with the now playing musical piece's crescendos coupled with animated acts choreographed with the music and the water dance; one or more sound generating, adjusting, mixing, synchronizing, modulating, time-varying, amplifying and/or broadcasting (wired and/or wireless, electronic, electrical and/or mechanical) system(s), circuit(s) and/or device(s); one or more light and/or laser source(s) 11; and one or more device modulator(s), switch(es) and/or controller(s) 8, 9 which modulate and/or control one or more parameter of the features of the apparatus and system; and one or more interactive microprocessing, computing and/or data-transmission system(s) and/or device(s) (including, without limitation, wired and/or wireless, monitor(s), keyboard(s), mouse(s) and other multilevel interaction input, multilevel channel communications output and/or memory device(s), user-interface device(s) and other microprocessing related software and hardware) 7 to capture, animate, delineate, caricature, formulate, digitize and/or co-ordinate light emissions, sound or musical notes and/or tunes being played and/or broadcasted and/or dancing water trajectories and durations with ad hoc, random, reconfigurable and/or pre-set motion and/or sound multilevel interaction inputs 3, produced and/or caused by and/or through interaction of human, animal and/or objects, into control data, signals and/or commands 7 which are delivered, automatically or on the demand(s), option(s) and/or desire(s) of the user(s), to the, switch, selector and/or controller 8 for connecting, controlling, coordinating and combining the height, trajectory and duration of liquid and/or vapour and/or gas emitted from the nozzle assembly(ies) 12, the sound generating, adjusting, mixing, synchronizing, modulating, time-varying, amplifying and/or broadcasting 10, and the mood, soft and/or hard lighting changes and/or laser renditions 11, in air and/or water, to make the height, trajectory and duration of liquid and/or vapour and/or gas emitted from the nozzle assembly(ies) 12 in tandem or accordance with the sound or musical pieces 10, beats and/or notes being played and/or broadcasted to produce life-like, integrated, stimulating, dramatic, artistic, aesthetic, sonic, musical, picturesque and featured entertaining performances and attainments choregraphed with light, music and water dance, automatically or on the demand(s), option(s) and/or desire(s) of the user(s). The invention includes nozzle assembly(ies) 12 for spraying and/or emitting liquid and/or vapour and/or gas that can produce a lively and entertaining liquid and/or vapour and/or gas screen and/or contour arrangement, including, without limitation, water screen and waterfalls of various thickness, augmented by lighting apparatus(es) 11, of desired configurations, orientations and dispositions, including, without limitation, water screen(s) and/or other media laser contour(s), arena-like and/or skysreen-like layout(s) of various different two-dimensional and/or three-dimensional shapes and/or sizes (which may comprise a middle drop/screen) or the like, placed and/or located at the centre(s) and/or focal zone(s) of the theatrical arrangement(s) for the entertainment apparatus and system so that the audience can be placed at various locations, including, without limitation, locations within or outside such water screen(s) and/or other media laser contour(s), arena-like and/or skyscreen-like layout(s), and be able to appreciate from different angles, points, locale, stations and positions, in particular, to enable viewing of a sequence at the reverse, or in Juxtaposition, so as to afford an additional dimension for creativity, the entertaining or theatrical effects, rendering or occasioning life-like, integrated, stimulating, dramatic, artistic, aesthetic, sonic, musical, picturesque and featured performances and attainments choregraphed with light, music and water dance, automatically or on the demand(s), option(s) and/or desire(s) of the user(s), on which light and/or laser imageries including, without limitation, well choreographed photographic, pictographic and/or animated characters and imageries as well as related collateral laser depictions (such as foreground and/or background scenes), of various colours, shades, shapes, sizes, designs, dispositions and/or orientations, and/or permutations and/or combinations whereof, can be projected corresponding to and/or in concert and/or sychronization with the melodies, sounds, voices, tones and crescendos prevailing in the environment in tunes, tempo and/or rhythm, with a view to enhancing the entertaining and/or theatrical effects, automatically or on the demand(s), option(s) and/or desire(s) of the user(s). The sound effects 10 may include, without limitation, distinctive hard sound effects, live recordings of sound effects that are synchronized with on-screen performances and attainments 11 choregraphed with light, music and water dance, ambience sound effects, electronic sound effects and design sound effects that may be impossible to record naturally.

In another embodiment, the nozzle assembly(ies) for spraying and/or emitting liquid and/or vapour and/or gas consists of groups of nozzles 12 of different or varied shapes, sizes, designs, dispositions and/or orientations, and/or permutations and/or combinations whereof, positioned, repositioned, deployed, utilized, controlled, activated, inactivated, excited and/or operated by one or more interactive device connector(s), switch(es), selector(s) and/or controller(s) 8, 9 with data, signal(s) and/or command(s) generated through programming and/or algorithmic computations of one or more interactive microprocessing, computing and/or data-transmission system(s), circuit(s) and/or device(s) (including, without limitation, wired and/or wireless, monitor(s), keyboard(s), mouse(s) and other multilevel channel communications input, multilevel channel communications output and/or memory device(s), user-interface device(s), animatronics and/or graphical user-interface, and computer-aided, robotic, cybernetic and/or manual adjustments and/or external data multilevel channel communications input functionalities and other microprocessing related software and hardware) 7, 8 connected thereto, and such nozzle assembly(ies) 12 can be operated upon as aforesaid in conjunction with the light and/or laser source(s) and laser rendition(s) 11 to produce life-like, integrated, stimulating, dramatic, artistic, aesthetic, sonic, musical, picturesque and featured entertaining performances and attainments choregraphed with light, music and water dance, automatically or on the demand(s), option(s) and/or desire(s) of the user(s). The resultant data so generated are automatically verified and assessed by one or more interactive microprocessing, computing and/or data-transmission system(s), circuit(s) and/or device(s) and/or by one or more interactive device connector(s), switch(es), selector(s), modulator(s) and/or controller(s) 7, to adjust, control, ascertain and ensure that each of the associated hardware (including, where appropriate, laser head movement-cum-beaming controllers, the relevant musical instrument(s) 3, the nozzle assembly(ies) 12 and the mechanical moving parts that (amongst other things) position, reposition, deploy, utilize, control, activate, inactivate, excite and/or operate the light and/or laser control and/or projection system(s) and/or device(s) or any part(s) whereof) is functioning properly and in the manner intended, and such computer software and/or program produces and/or generates appropriate alerts and produces interactive and/or appropriate data, signal(s) and/or command(s) for alternative execution plans and/or programmes, with or without manual over-ride(s) and/or change(s), whether by ways and/or means of rescaling of the length of the relevant beat(s), time frame(s), timeline(s) and/or time signature(s), for (amongst other things) rescaling the spraying height(s) of the relevant nozzle or group(s) of nozzles or adjusting, coordinating and/or synchronizing the positions and operations of the light and/or laser control and/or projection system(s), circuit(s) and/or device(s) 11 to produce life-like, integrated, stimulating, dramatic, artistic, aesthetic, sonic, musical, picturesque and featured entertaining performances and attainments choregraphed with light, music and water dance, automatically or on the demand(s), option(s) and/or desire(s) of the user(s), correspondence with, in particular, the time frame(s), timeline(s) and time signature(s) of the sonic, musical performance(s), and the loudness, softness, tempo, rhythm, and the position and/or notation on a musical stave, the clef and relative length of each note, beat and/or bar, and the crescendos and diminuendos of sonic and/or musical renditions being broadcasted, so as to produce interactive and/or appropriate data, signal(s) and/or command(s) for the suitable lighting conditions and/or laser renditions, in terms of the operation, activation, inactivation, tone, colour, brightness, dimness, strength and weakness of each light and/or laser source(s), for producing the life-like, integrated, stimulating, dramatic, artistic, aesthetic, sonic, musical, picturesque and featured performances and attainments choregraphed with light, music and water dance, automatically or on the demand(s), option(s) and/or desire(s) of the user(s). Laser performances 11 may include single or multiple color presentation using one or more laser (which can be mixed-gas ion laser and/or solid state RGB diode lasers) that produces one or more wavelength, or two or more lasers in concert and combination to produce a single beams using dichronic and/or dielectric mirror(s) and/or similar device(s) that result in reasonable mixtures of colours and intensities that are aligned to each other.

In another embodiment, the invention includes one or more device(s) that capture and store original sound or musical recording(s), generate sound or musical timeline(s) and associate(s), cross-reference and co-ordinate such sound or musical timeline(s) with other designated timeline(s).

In another embodiment, the invention includes one or more imagery multilevel interaction input and/or capturing (wired and/or wireless, electronic, electrical and/or mechanical) system(s), circuit(s) and/or device(s) 2 and/or one or more sound multilevel interaction input and/or capturing (wired and/or wireless, electronic, electrical and/or mechanical) system(s), circuit(s) and/or device(s) 3 and/or one or more camera or motion multilevel interaction input and/or sensoring (wired and/or wireless, electronic, electrical and/or mechanical) system(s), circuit(s) and/or device(s) 4, strategically placed at, in or about the location of the invention, send interactive and/or appropriate data, signal(s) and/or command(s) to one or more interactive micro-processing, computing and/or data-transmission system(s), circuit(s) and/or device(s) (including, without limitation, wired and/or wireless, monitor(s), keyboard(s), mouse(s) and other multilevel channel communications input, multilevel channel communications output and/or memory device(s), user-interface device(s) and other micro-processing related software and hardware) 7 and/or to one or more interactive device connector(s), switch(es), selector(s) and/or controller(s), and data, signal(s) 8, 9 and/or command(s) are in turn issued to one or more nozzle assembly(ies) 12 for spraying and/or emitting liquid and/or vapour and/or gas and/or one or more wired and/or wireless sound generating, adjusting, mixing, synchronizing, modulating, time-varying, amplifying and/or broadcasting (wired and/or wireless, electronic, electrical and/or mechanical) system(s), circuit(s) and/or device(s) 10 and/or one or more light and/or laser source(s) and/or projector(s) 11, for positioning and/or rendering in three-dimensional orientation(s), deployment(s), condition(s), utilization(s), action(s) and/or operation(s) of the nozzle assembly(ies) 12, coupled with sound generating, adjusting, mixing, synchronizing, modulating, time-varying, amplifying and/or broadcasting 10, and the mood, soft and/or hard lighting changes and/or laser renditions 11 (including, without limitation, three-dimensional tactile holograms and/or other holographic displays, projections and/or presentations, and holograph and water displays, projections and/or presentations), to produce life-like, integrated, stimulating, dramatic, artistic, aesthetic, sonic, musical, picturesque and featured performances and attainments choregraphed with light, music and water dance, automatically or on the demand(s), option(s) and/or desire(s) of the user(s).

In one embodiment, the invention includes one or more light and/or laser source(s) 11 and/or one or more enclosure(s) which are waterproof and weatherproof to protect the light and/or laser source(s) and the related components from the inclement weather and can be easily accessed for periodic maintenance and servicing. The irradiation from the light and/or laser source(s) can be randomly oriented and/or purposefully directional in order to cater to the needs of and to suit the life-like, integrated, stimulating, dramatic, artistic, aesthetic, sonic, musical, picturesque and featured performances and attainments choregraphed with light, music and water dance, automatically or on the demand(s), option(s) and/or desire(s) of the user(s).

In another embodiment, the invention includes one or more interactive microprocessing, computing and/or data-transmission system(s), circuit(s) and/or device(s) (including, without limitation, wired and/or wireless, monitor(s), keyboard(s), mouse(s) and other multilevel channel communications input, multilevel channel communications output and/or memory device(s), user-interface device(s) and other microprocessing related software and hardware) 7 and/or one or more interactive device connector(s), switch(es), selector(s) and/or controller(s) 8, 9 take into account the environ lighting and related conditions in which the invention is placed and/or located, including, without limitation, considerations such as (a) whether the sky is bright, cloudy or dark; (b) whether the relevant time of the entertainment is during the day or after dark; (c) whether the invention is located indoors and/or outdoors, and/or is placed under bright sunlight or located under shades, etc. so as to produce interactive and/or appropriate data, signal(s) and/or command(s) for the suitable lighting conditions for producing the life-like, integrated, stimulating, dramatic, artistic, aesthetic, sonic, musical, picturesque and featured performances and attainments choregraphed with light, music and water dance, automatically or on the demand(s), option(s) and/or desire(s) of the user(s).

In another embodiment, the invention includes, wired and/or wireless, device modulator(s), switch(es) and/or controller(s) 8, 9 which, when activated automatically or on the demand(s), option(s) and/or desire(s) of the user(s), capture, adjust, coordinate, synchronize, integrate, ascertain and ensure the full effects, functions and controls of one or more of the associated hardware of the invention (including, where appropriate, wired and/or wireless, power switch(es) and management device(s), power adapter(s), wake-up device(s), system(s), circuit(s) and/or device(s), timer(s) and/or other timing system(s), circuit(s) and/or device(s), imagery multilevel interaction input and/or capturing (wired and/or wireless, electronic, electrical and/or mechanical) system(s), circuit(s) and/or device(s), 2 sound multilevel interaction input and/or capturing (wired and/or wireless, electronic, electrical and/or mechanical) system(s), circuit(s) and/or device(s) 3, camera and/or motion multilevel interaction input and/or sensoring (wired and/or wireless, electronic, electrical and/or mechanical) system(s), circuit(s) and/or device(s) 4, light and/or laser source(s) and/or laser head(s) movement-cum-beaming controller(s) 11, the sound or musical instrument(s), the symphony orchestra and/or other sound generating, adjusting, mixing, synchronizing, modulating, time-varying, amplifying and/or broadcasting (wired and/or wireless, electronic, electrical and/or mechanical) system(s), circuit(s) and/or device(s) 10, the nozzle(s) and/or nozzle assembly(ies) 12 and the mechanical moving part(s) that (amongst other things) position, reposition, deploy, utilize, control, activate, inactivate, excite and/or operate the invention or any part or parts thereof) are functioning properly and in the manner intended, to higher lever user-interfaces, for easy arrangements of specifications and choreographies, automatically or on the demand(s), option(s) and/or desire(s) of the user(s). The arrangements and distributions of the nozzle(s) and/or nozzle assembly(ies) over a water-fountain/aquatic theatre can be made in accordance with how and from where the sound or musical instrument(s) of the symphony orchestra and/or other sound generating, adjusting, mixing, synchronizing, modulating, time-varying, amplifying and/or broadcasting (wired and/or wireless, electronic, electrical and/or mechanical) system(s), circuit(s) and/or device(s) 10 are located and/or distributed on a performing stage (including, without limitation, water screen(s) and/or other media and/or contour(s) of arena-like and/or skyscreen-like layout(s) (which may comprise a middle drop/screen) or the like 10, 11, placed and/or located at the centre of the theatrical arrangement(s) for the invention.

In another embodiment, the invention includes one or more sound multilevel interaction input and/or capturing (wired and/or wireless, electronic, electrical and/or mechanical) system(s), circuit(s) and/or device(s) 3 and/or one or more camera and/or motion multilevel interaction input and/or sensoring (wired and/or wireless, electronic, electrical and/or mechanical) system(s), circuit(s) and/or device(s) 4, connected to and sends interactive and/or appropriate data, signal(s) and/or command(s) to one or more interactive device connector(s), switch(s), selector(s) and/or controller(s) which control, adjust, coordinate, synchronize, ascertain and ensure the associated hardware of the invention and/or one or more interactive microprocessing, computing and/or data-transmission system(s), circuit(s) and/or device(s) (including, without limitation, wired and/or wireless, monitor(s), keyboard(s), mouse(s) and other multilevel interaction input, multilevel channel communications output and/or memory device(s), user-interface device(s) and other microprocessing related software and hardware) 7 and/or one or more timer and/or other timing system(s), circuit(s) and/or device(s), when the one or more sound multilevel interaction input and/or capturing (wired and/or wireless, electronic, electrical and/or mechanical) system(s), circuit(s) and/or device(s) receives note and/or sound multilevel channel communications input data and/or signal(s) above (pre-set, automatically and/or manually set) threshold 3 and/or one or more imagery, camera and/or motion multilevel interaction input and/or sensoring (wired and/or wireless, electronic, electrical and/or mechanical) system(s), circuit(s) and/or device(s) 2, 4 which detects movement and/or motion multilevel interaction input data and/or signal(s) above (pre-set, automatically and/or manually set) threshold(s) to activate or inactivate the invention or any part(s) thereof for intended and/or desired purposes and/or functionalities.

In another embodiment, the invention includes sound or musical instruments, synthesizers and mixers 3 for randomly selected and/or designated original sound and/or musical multilevel interaction inputs and/or multilevel channel communications outputs and designated time frames, timelines and/or time signatures, are connected to and can, in response and/or conform to progressive imageries encapsulated, the melodies, sounds, voices, tones prevailing in the environment in tunes, tempo and/or rhythm, and the motions and/or movements of persons, objects and/or animations present in the environment at any time, issued data, signals and/or commands to position, reposition, deploy, utilize, control, activate, inactivate, excite and/or operate (a) nozzle assembly(ies) of various nozzles of shapes, sizes, elevations, orientations, three-dimensional motion speeds, rotational speeds, pressurized fluid flows, fluid flow speeds, flow trajectories and similar functionalities 12; (b) various singular or plural light and/or laser source(s) (including, without limitation, directions, quantities, qualities, intensities, colors, shades, white balancing (automatic, preset and/or manual), temperatures, temperature shifts, timing thereof) 11; and (c) various sound generating, adjusting, mixing, synchronizing, modulating, time-varying, amplifying and/or broadcasting (wired and/or wireless, electronic, electrical and/or mechanical) system(s), circuit(s) and/or device(s) 10; each strategically positioned, elevated, moved and/or oriented in or about the location of the invention so that water jets and/or screens and spray patterns produced, lighting environments displayed and sound or musical notes and/or tunes presented can, in concert and/or sychronization and, with a view to enhancing the entertaining and/or theatrical effects, render and/or occasion life-like, integrated, stimulating, dramatic, artistic, aesthetic, sonic, musical, picturesque and featured entertaining performances and attainments choregraphed with light, music and water dance, when activated automatically or on the demand(s), option(s) and/or desire(s) of the user(s).

In another embodiment, the invention further includes, wired and/or wireless, device modulator(s), switch(es) and/or controller(s) 9 which, when activated automatically or on the demand(s), option(s) and/or desire(s) of the user(s), capture, incorporate, adjust, coordinate, synchronize, integrate with one or more of the other hardware of the invention the full effects, functions and controls of (1) one or more tactile stimulus multilevel channel communications input and/or multilevel channel communications output (wired and/or wireless, electronic, electrical and/or mechanical) system(s), circuit(s) and/or device(s), and/or one or more heating or cooling device(s) adapted to provide tactile sensation 15; (2) one or more olfactory stimulus multilevel channel communications input and/or multilevel channel communications output (wired and/or wireless, electronic, electrical and/or mechanical) system(s), circuit(s) and/or device(s) 13; (3) one or more gustatory stimulus multilevel channel communications input and/or multilevel channel communications output (wired and/or wireless, electronic, electrical and/or mechanical) system(s), circuit(s) and/or device(s) 14.

In another embodiment, the invention further includes one or more tactile stimulus multilevel interaction input 6 and/or multilevel channel communications output 15 (wired and/or wireless, electronic, electrical and/or mechanical) system(s), circuit(s) and/or device(s) 6, 15; and/or one or more heating or cooling device(s) adapted to provide tactile sensations of three-dimensional movement, motions and/or tiltings and/or temperature alterations according to the occurrence of one or more events (random, reconfigurable and/or pre-set) 15 and/or the multilevel channel communications input from one or more user-interface and/or computer-interface device(s) 9 for enabling, disabling and/or adjusting such device(s).

In another embodiment, the invention further includes one or more olfactory stimulus multilevel interaction input 1 and/or multilevel channel communications output (wired and/or wireless, electronic, electrical and/or mechanical) system(s), circuit(s) and/or device(s) 13, including, without limitation, pump sprayer(s), atomizer(s) and/or aerosol device(s) with liquid container(s), that delivers and/or releases (including, without limitation, timed multilevel channel communications output and/or release) measured and/or minute amounts of fragrances and/or other olfactory compositions, dispersions, emulsions, solutions and/or atomized particles, including, without limitation, mixtures, matrices, hybrids and/or combinations of natural, organic, inorganic, synthetic, and/or other odoriferous substances, materials and/or matters, including, without limitation, other solvents, adjuvants, additives, surfactants and/or olfactory stimulus emitting substances, materials and/or matters commonly used and/or exploited in the field of perfumery and/or olfactory effects 13, into the atmosphere for immediate detection by the olfactory senses (including, without limitation, short-lived and/or long-lasting sensations), according to the occurrence of one or more events (random, reconfigurable and/or pre-set) and/or the multilevel channel communications input from one or more user-interface and/or computer-interface device(s) 9 for enabling, disabling and/or adjusting such device(s).

In another embodiment, the invention further includes one or more gustatory stimulus multilevel interaction input 5 and/or multilevel channel communications output (wired and/or wireless, electronic, electrical and/or mechanical) system(s), circuit(s) and/or device(s) 14 which simulates, generates and/or synthesizes time-varied and/or scalable electrical data, signals and/or configurations (including, without limitation, voltage waveforms and/or other potential curves and/or characteristics) corresponding to and/or commensurate with the desired perceivable stimulus of and/or relating to lingual papillae and/or gustatory organ(s), including salty, bitter, sweet, astringent, pungent, umami and/or sour tastes and/or effects and/or any permutation and/or combination whereof, according to the occurrence of at least an event (random, reconfigurable and/or pre-set) and/or the multilevel channel communications input from one or more user-interface device(s) for enabling, disabling and/or adjusting such gustatory stimulus multilevel channel communications input and/or multilevel channel communications output device(s) 9, according to the occurrence of one or more events (random, reconfigurable and/or pre-set) and/or the multilevel channel communications input from one or more user-interface and/or computer-interface device(s) for enabling, disabling and/or adjusting such device(s).

This invention has an enormously wide scope of objects, applications and users.

Those of skill in the art are fully aware that, numerous hybrids, permutations, modifications, variations and/or equivalents of the present invention and in the particular embodiments exemplified, are possible and can be made in light of the above invention and disclosure without departing from the spirit thereof and/or the scope of the claims in this disclosure. It is important that the claims in this disclosure be regarded as inclusive of such hybrids, permutations, modifications, variations and/or equivalents. Those of skill in the art will appreciate that the idea and concept on which this disclosure is founded may be utilized and exploited as a basis or premise for devising and designing other structures, configurations, constructions, applications, systems, apparatuses and methods for implementing or carrying out the gist, essence, objects and/or purposes of the present invention. In regards to the above embodiments, diagrams and descriptions, those of skill in the art will further appreciate that the physical construction and the optimum dimension, orientation, configuration and/or other relationships and/or interactions for and amongst the parts and/or components of the present invention and disclosure, which include, but without limitation, variations in sizes, materials, substances, matters, shapes, scopes, forms, functions and manners of operations and inter-actions, assemblies and users, are deemed readily apparent and obvious to one skilled in the art, and all equivalent relationships and/or projections to or of those illustrated in the drawing figures and described in the specifications are intended to be encompassed by, included in, and form part and parcel of the present invention and disclosure. Accordingly, the foregoing is considered as illustrative and demonstrative only of the ideas or principles of the invention and disclosure. Further, since numerous hybrids, permutations, modifications, variations and/or equivalents will readily occur to those skilled in the art, it is not desired to limit the present invention and disclosure to the exact functionality, assembly, construction, configuration and operation shown and described, and accordingly, all suitable hybrids, permutations, modifications, variations and/or equivalents may be resorted to, falling within the scope of the present invention and disclosure.

1. An entertainment apparatus and system including:
at least one imagery multilevel interaction input and/or capturing (wired and/or wireless, electronic, electrical and/or mechanical) device;
at least one sound multilevel interaction input and/or capturing (wired and/or wireless, electronic, electrical and/or mechanical) device;
at least one camera and/or motion multilevel interaction input or sensoring (wired and/or wireless, electronic, electrical and/or mechanical) device;
at least one nozzle assembly for spraying or emitting liquid and/or vapour and/or gas, with different sizes of nozzles associated (automatically, preset and/or manually) with different musical instruments and to attain spray (automatically, preset and/or manually) configurated, systematized and/or choreographed in accordance with sound and/or musical notes and/or tunes being played, and for duration of spray trajectory to last at least one beat length of at least one musical note, and to add twists and turns in tandem with the crescendos of the musical piece instantly being played and coupled with animated acts choreographed with the music and the water dance;
at least one light and/or laser (wired and/or wireless, electronic, electrical and/or mechanical) source;
at least one (wired and/or wireless, electronic, electrical and/or mechanical) interactive device connector, switch, selector, modulator and/or controller (collectively, “Device Controller”) which connects, activates, inactives, excites, operates, modulates, positions, repositions, deploys, utilizes, combines and/or controls, automatically or on the demand(s), option(s) and/or desire(s) of the user(s), at least one nozzle assembly for spraying or emitting liquid and/or vapour and/or gas, at least one imagery multilevel interaction input or capturing device, at least one sound multilevel interaction input or capturing device, at least one camera and/or motion multilevel interaction input or sensoring device, at least one sound generating, adjusting, mixing, synchronizing, modulating, time-varying, amplifying and/or broadcasting device, and/or at least one light and/or laser source;
at least one interactive microprocessing, computing or data-transmission system, circuit and/or device (collectively, “Microprocessing Device”) to signal, command, capture, animate, delineate, caricature, formulate, digitize and co-ordinate, ad hoc, random, reconfigurable and/or pre-set motion and/or sound multilevel channel communications inputs which are delivered to at least one Device Controller which connects, activates, inactives, excites, operates, modulates, positions, repositions, deploys, utilizes, combines and/or controls at least one nozzle assembly and at least one trajectory of at least one liquid and/or vapour and/or gas emitted from the nozzle assembly, the sound generating, adjusting, mixing, synchronizing, modulating, timing, time-varying, amplifying and/or broadcasting coordinated with the mood, soft or hard lighting changes or laser renditions, in air or water, to produce life-like, integrated, stimulating, dramatic, artistic, aesthetic, sonic, musical, picturesque and featured entertaining performances and attainments choregraphed with light, music and water dance (hence a different water dance/spray for a different musical note or tune) automated or on the demand(s), option(s) and/or desire(s) of the user(s).

2. The apparatus and system in claim 1, wherein at least one nozzle assembly includes nozzles of shapes, sizes, designs, elevations, dispositions, orientations, three-dimensional motion speeds, rotational speeds, pressurized fluid flows, fluid flow speeds, flow trajectories and similar functionalities and/or various permutations and/or combinations whereof.

3. The apparatus and system in claim 1, wherein at least one nozzle assembly is placed or located at or near the centre(s) or focal zone(s) of the theatrical arrangement(s) for the entertainment apparatus and system.

4. The apparatus and system in claim 1, wherein at least one which may comprise one or more middle drop(s)/screen(s) or the like, nozzle assemblies for spraying and/or emitting liquid and/or vapour and/or gas that can produce lively and entertaining liquid and/or vapour and/or gas screen and/or middle drop(s)/screen(s)and/or other arena-like and/or skyscreen-like layout(s), screen(s), and/or arrangement(s), including film(s) of water sprays and waterfalls of various thickness, of various shapes and/or sizes, located at or near the centre(s) or focal zone(s) of the theatrical arrangement(s) for the entertainment apparatus and system of desired configuration(s), orientation(s) and disposition(s), on to which liquid and/or vapour and/or gas screen and/or middle drop(s)/screen(s)and/or other arena-like and/or skyscreen-like layout(s), screen(s), and/or arrangement(s) can be projected, augmented by and operated in conjunction with, harmonized and/or sychronized light and/or laser source for entertaining lighting and/or laser shows, automated or on the demand(s), option(s) and/or desire(s) of the user(s).

5. The apparatus and system in claim 1, wherein the light and/or laser source includes at least one light and/or laser control or projection system and/or device, randomly oriented and/or purposefully directional, to produce laser performances.

6. The apparatus and system in claim 1, wherein the light and/or laser source includes laser head(s) movement-cum-beaming controller(s).

7. The apparatus and system in claim 1, wherein the Microprocessing Device and/or the Device Controller, automatically or on the demand(s), option(s) and/or desire(s) of the user(s), takes into account the environ lighting and related conditions in which the apparatus and system are placed and/or located, including (a) whether the sky is bright, cloudy or dark; (b) whether the relevant time of the entertainment is during the day or after dark; (c) whether the invention is located indoors and/or outdoors, and/or is placed under bright sunlight or located under shades and so forth, so as to produce interactive and/or appropriate data, signal(s) and/or command(s) for the suitable lighting conditions for producing the life-like, integrated, stimulating, dramatic, artistic, aesthetic, sonic, musical, picturesque and featured performances and attainments choregraphed with light, music and water dance, automatically or on the demand(s), option(s) and/or desire(s) of the user(s).

8. The apparatus and system in claim 1, wherein the light and/or laser source includes one or more enclosure(s) which are waterproof and weatherproof to protect the light and/or laser source(s) and the related components from the inclement weather and can be easily accessed for periodic maintenance and servicing.

9. The apparatus and system in claim 1, wherein the light and/or laser source produces laser performance with single or multiple color presentation using one or more laser (which can be mixed-gas ion laser and/or solid state RGB diode lasers) that produces one or more wavelength, or two or more lasers in concert and combination to produce a single beams using dichronic and/or dielectric mirror(s) and/or similar device(s) that result in reasonable mixtures of colours and intensities that are aligned to each other.

10. The apparatus and system in claim 1, wherein the light and/or laser source is capable of producing mood, soft and/or hard lighting changes and/or laser renditions, including, without limitation, three-dimensional tactile holograms and/or other holographic displays, projections and/or presentations, including, without limitation, well choreographed photographic, pictographic and/or animated characters and imageries as well as related collateral laser depictions (such as foreground and/or background scenes), of various colours, shades, shapes, sizes, designs, dispositions and/or orientations, and/or permutations and/or combinations whereof, can be projected corresponding to and/or in concert and/or sychronization with the melodies, sounds, voices, tones and crescendos prevailing in the environment in tunes, tempo and/or rhythm, with a view to enhancing the entertaining and/or theatrical effects, automatically or on the demand(s), option(s) and/or desire(s) of the user(s).

11. The apparatus and system in claim 1, wherein the sound multilevel interaction input and/or capturing device captures and stores original sound or musical recording(s), generate sound or musical timeframe(s), timeline(s) and time signature(s), and cross-reference and co-ordinate such sound or musical timeline(s) with other designated timeline(s).

12. The apparatus and system in claim 1, wherein the light and/or laser source include single or multiple color presentation using one or more laser (which can be mixed-gas ion laser and/or solid state RGB diode lasers) that produces one or more wavelength, or two or more lasers in concert and combination to produce a single beams using dichronic and/or dielectric mirror(s) and/or similar device(s) that result in reasonable mixtures of colours and intensities that are aligned to each other.

13. The apparatus and system in claim 1, wherein the Microprocessing Device includes wired and/or wireless, monitor(s), keyboard(s), mouse(s) and other multilevel channel communications input, multilevel channel communications output and/or memory device(s), user-interface device(s) and other microprocessing related software and hardware).

14. The apparatus and system in claim 1, wherein the Microprocessing Device and/or the Device Controller automatically or in preset manner verifies and assesses the data and/or signals so generated by the Microprocessing Device and/or interact with the Microprocessinng Device to adjust, control, ascertain and ensure that each of the associated hardware (including, amongst other things, laser head movement-cum-beaming controllers, the relevant musical instrument(s), the nozzle assembly(ies) and the mechanical moving parts that position, reposition, deploy, utilize, control, activate, inactivate, excite and/or operate the light and/or laser control and/or projection system(s) and/or device(s) or any part(s) whereof) is functioning properly and in the manner intended.

15. The apparatus and system in claim 1, wherein the Microprocessing Device and/or the Device Controller automatically or in preset manner alerts and produces interactive and/or appropriate data, signal(s) and/or command(s) for alternative execution plans and/or programmes, with or without manual over-ride(s) and/or change(s), whether by ways and/or means of rescaling of the length of the relevant beat(s), time frame(s), timeline(s) and/or time signature(s), for rescaling the spraying height(s) of the relevant nozzle or group(s) of nozzles or adjusting, coordinating and/or synchronizing the positions and operations of the light and/or laser control and/or projection system(s), circuit(s) and/or device(s) to produce life-like, integrated, stimulating, dramatic, artistic, aesthetic, sonic, musical, picturesque and featured entertaining performances and attainments choregraphed with light, music and water dance, automatically or on the demand(s), option(s) and/or desire(s) of the user(s).

16. The apparatus and system in claim 1, wherein the Microprocessing Device and/or the Device Controller automatically or in preset manner alerts and produces interactive and/or appropriate data, signal(s) and/or command(s) for alternative execution plans and/or programmes, in correspondence, in particular, with the time frame(s), timeline(s) and time signature(s) of the sonic, musical performance(s), and the loudness, softness, tempo, rhythm, and the position and/or notation on a musical stave, the clef and relative length of each note, beat and/or bar, and the crescendos and diminuendos of sonic, musical renditions being broadcasted, so as to produce interactive and/or appropriate data, signal(s) and/or command(s) for the suitable lighting conditions and/or laser renditions, in terms of the operation, activation, inactivation, tone, colour, brightness, dimness, strength and weakness of each light and/or laser source(s), for producing the life-like, integrated, stimulating, dramatic, artistic, aesthetic, sonic, musical, picturesque and featured performances and attainments choregraphed with light, music and water dance, automatically or on the demand(s), option(s) and/or desire(s) of the user(s).

17. The apparatus and system in claim 1, wherein the imagery multilevel interaction input or capturing device, at random or in response to fully or partially captured pre-set imageries, automated or on the demand(s), option(s) and/or desire(s) of the user(s), sends and/or receives at least one datum and/or signal to at least one interactive microprocessing, computing or data-transmission system(s) or device(s) (including, without limitation, wired and/or wireless, monitor(s), keyboard(s), mouse(s) and other multilevel interaction input, multilevel channel communications output and/or memory device(s), user-interface device(s) and other microprocessing related software and hardware) and/or to at least one interactive device connector, switch, selector and/or controller.

18. The apparatus and system in claim 1, wherein the sound multilevel interaction input or capturing device, at random or in response to fully or partially captured pre-set sound patterns, sends and/or receives at least one datum and/or signal to the Microprocessing Device and/or the Device Controller.

19. The apparatus and system in claim 1, wherein the camera and/or motion multilevel interaction input or sensoring device, at random or in response to fully or partially captured pre-set motion patterns, automated or on the demand(s), option(s) and/or desire(s) of the user(s), sends and/or at least one datum and/or signal to the Microprocessing Device and/or the Device Controller.

20. The apparatus and system in claim 1 further include at least one, wired and/or wireless, interactive device modulator(s), switch(es) and/or controller(s) (“Device Modulator”) which, when activated automatically or on the demand(s), option(s) and/or desire(s) of the user(s), capture, incorporate, adjust, coordinate, synchronize, integrate with the Device Controller and/or one or more of the other hardware of the invention, the full effects, functions and controls of (1) one or more tactile stimulus multilevel channel communications input and/or multilevel channel communications output (wired and/or wireless, electronic, electrical and/or mechanical) system(s), circuit(s) and/or device(s), and/or one or more heating or cooling device(s) adapted to provide tactile sensation; and/or (2) one or more olfactory stimulus multilevel interaction input and/or multilevel channel communications output (wired and/or wireless, electronic, electrical and/or mechanical) system(s), circuit(s) and/or device(s); and/or (3) one or more gustatory stimulus multilevel interaction input and/or multilevel channel communications output (wired and/or wireless, electronic, electrical and/or mechanical) system(s), circuit(s) and/or device(s).

21. The apparatus and system in claim 20 wherein the tactile stimulus multilevel interaction input and/or multilevel channel communications output (wired and/or wireless, electronic, electrical and/or mechanical) system(s), circuit(s) and/or device(s); and/or one or more heating or cooling device(s) adapted to provide tactile sensations of three-dimensional movement, motions and/or tiltings and/or temperature alterations according to the occurrence of one or more events (random, reconfigurable and/or pre-set) and/or the multilevel interaction input from one or more user-interface and/or computer-interface device(s) for enabling, disabling and/or adjusting such device(s).

22. The apparatus and system in claim 20 wherein the olfactory stimulus multilevel interaction input and/or multilevel channel communications output (wired and/or wireless, electronic, electrical and/or mechanical) system(s), circuit(s) and/or device(s), including, without limitation, pump sprayer(s), atomizer(s) and/or aerosol device(s) with liquid container(s), that delivers and/or releases (including, without limitation, timed multilevel channel communications output and/or release) measured and/or minute amounts of fragrances and/or other olfactory compositions, dispersions, emulsions, solutions and/or atomized particles, including, without limitation, mixtures, matrices, hybrids and/or combinations of natural, organic, inorganic, synthetic, and/or other odoriferous substances, materials and/or matters, including, without limitation, other solvents, adjuvants, additives, surfactants and/or olfactory stimulus emitting substances, materials and/or matters commonly used and/or exploited in the field of perfumery and/or olfactory effects, into the atmosphere for immediate detection by the olfactory senses (including, without limitation, short-lived and/or long-lasting sensations), according to the occurrence of one or more events (random, reconfigurable and/or pre-set) and/or the multilevel channel communications input from one or more user-interface and/or computer-interface device(s) for enabling, disabling and/or adjusting such device(s).

23. The apparatus and system in claim 20 wherein the gustatory stimulus multilevel interaction input and/or multilevel channel communications output (wired and/or wireless, electronic, electrical and/or mechanical) system(s), circuit(s) and/or device(s) simulates, generates and/or synthesizes time-varied and/or scalable electrical data, signals and/or configurations (including, without limitation, voltage waveforms and/or other potential curves and/or characteristics) corresponding to and/or commensurate with the desired perceivable stimulus of and/or relating to lingual papillae and/or gustatory organ(s), including salty, bitter, sweet, astringent, pungent, umami and/or sour tastes and/or effects and/or any permutation and/or combination whereof, according to the occurrence of at least an event (random, reconfigurable and/or pre-set) and/or the multilevel channel communications input from one or more user-interface device(s) for enabling, disabling and/or adjusting such gustatory stimulus multilevel channel communications input and/or multilevel channel communications output device(s), according to the occurrence of one or more events (random, reconfigurable and/or pre-set) and/or the multilevel channel communications input from one or more user-interface and/or computer-interface device(s) for enabling, disabling and/or adjusting such device(s).
